(19) United States
(12) Patent Application Publication
(10) Pub. No.: US 2011/0130907 A1
(43) Pub. Date: Jun. 2, 2011

(54) POWER SOURCE MODULE AND METHOD FOR USING THE SAME

(75) Inventors: Tien Ho GAU, Hsinchu City (TW); Yu Yin Peng, Hsinchu City (TW); Hakan Olsson, Skepplanda (SE)

(73) Assignee: INDUSTRIAL TECHNOLOGY RESEARCH INSTITUTE, Chutung (TW)

(21) Appl. No.: 12/685,771

(22) Filed: Jan. 12, 2010

(30) Foreign Application Priority Data
Nov. 27, 2009 (TW) 098140485

(51) Int. Cl. B60W 20/00; H02J 7/00; G06F 7/00; B60W 10/06; B60W 10/08; B60W 10/26

(52) U.S. Cl. 701/22; 320/132; 903/907

(57) ABSTRACT

A power source module comprises a plurality of socket modules, at least one exchangeable battery module, and at least one system control unit. The socket modules are connected in parallel. The exchangeable battery module can be arbitrarily inserted into one of the socket modules. The system control unit is configured to transmit an instruction signal for controlling a switch of the exchangeable battery module according to a state of charge of the exchangeable battery module, a sensing result, and operating information of an external device (for example, a motor or a charger), so as to charge or discharge only one exchangeable battery module during a charging and discharging period.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The disclosure relates to a power source module and method for using the same.

2. Description of Related Art

Including Information Disclosed Under 37 CFR 1.97 and 37 CFR 1.98.

Electric vehicles and hybrid electric vehicles are becoming increasingly popular and various applications thereof are being developed rapidly. Accordingly, many teams are devoted to the research of power management control. U.S. Pat. No. 5,960,898 discloses a power supply unit which provides electric power to an electric vehicle using a capacitor unit. The capacitor unit includes at least two blocks each having a plurality of electric double-layer capacitors connected in series. The power supply unit changes connection states (parallel or serial) according to the load requirement of the electric vehicle.

U.S. Pat. No. 5,706,910 discloses a power source switching system which switches connection states of a plurality of batteries using a switching circuit. The switching circuit operates according to an instruction from a control device. The instruction from the control device is executed according to a signal detected by a discriminating means. When the discriminating means detects the occurrence of an external shock, the signal is transmitted to the control device so as to change the connection state of the batteries from a serial connection to a parallel connection, thus preventing short circuiting.

U.S. Patent Publication No. 2008/0252148 discloses a power system including a battery, a generator, and a switch. The generator is connected in parallel with the battery and the switch. If the power generated by the generator is insufficient for the requirement of a vehicle during the motion of the vehicle, both the generator and the battery will supply power to the vehicle by controlling the switch. On the basis of the above, the control of the power management is a significant issue in the related field of electric vehicles and hybrid electric vehicles.

### BRIEF SUMMARY OF THE INVENTION

The disclosure relates to a power source module and method for using the same. According to one exemplary embodiment, a power source module comprises a plurality of socket modules, at least one exchangeable battery module, and at least one system control unit. The socket modules are connected in parallel. The exchangeable battery module can be arbitrarily inserted into one of the socket modules. The system control unit is configured to transmit an instruction signal for controlling a switch of the exchangeable battery module according to a state of charge of the exchangeable battery module, a sensing result, and operating information of an external device (for example, a motor or a charger), so as to charge or discharge only one exchangeable battery module during a charging and discharging period.

According to another exemplary embodiment, a power source module comprises a plurality of socket modules, at least one exchangeable battery module, and at least one system control unit. The socket modules are connected in parallel. The exchangeable battery module can be arbitrarily inserted into one of the socket modules. The system control unit is configured to control a switch of the socket module according to a state of charge of the exchangeable battery module, a sensing result, and operating information of an external device (for example, a motor or a charger), so as to charge or discharge only one exchangeable battery module during a charging and discharging period.

According to yet another exemplary embodiment, a power source module comprises a plurality of socket modules, at least one exchangeable battery module, and at least one system control unit. The exchangeable battery module can be arbitrarily inserted into one of the socket modules. The system control unit is configured to switch the socket modules connected in parallel or in series or to transmit an instruction signal for controlling a switch of the exchangeable battery module according to a state of charge of the exchangeable battery module, a sensing result, and operating information of an external device (for example, a motor or a charger).

According to yet another exemplary embodiment, a power source module comprises a plurality of socket modules, at least one exchangeable battery module, and at least one system control unit. The exchangeable battery module can be arbitrarily inserted into one of the socket modules. The system control unit is configured to switch the socket modules connected in parallel or in series or to control a switch of the socket modules according to a state of charge of the exchangeable battery module, a sensing result, and operating information of an external device (for example, a motor or a charger).

Yet another exemplary embodiment discloses a method of using a power source module. First, a device control unit determines whether a state of charge of an exchangeable battery module in a power source module is lower than a first threshold value, for example 10%. If the state of charge is lower than the first threshold value, the device control unit then determines whether a motion state of a vehicle is in a preferred switching state. If the motion state of the vehicle is in a preferred switching state, a turn-off step is performed. If the device control unit determines that the motion state of the vehicle is not in the preferred switching state, then the device control unit determines whether the state of charge of the exchangeable battery module is lower than a second threshold value, for example 5%. If the state of charge of the exchangeable battery module is lower than the second threshold value, then the turn-off step is performed. If the state of charge of the exchangeable battery module is not lower than the second threshold value, then the device control unit determines whether the exchangeable battery module is in an abnormal state. If the exchangeable battery module is in the abnormal state, then the turn-off step is performed. In the turn-off step, the device control unit stops a torque output of an external device (for example, a motor) through a main battery management control unit. After performing the turn-off step, the device control unit determines whether the output current of the first exchangeable battery module is zero. If YES, the device control unit activates another exchangeable battery module through the main battery management control unit for providing required power to the external device.

Yet another exemplary embodiment discloses a method of using a power source module. First, a device control unit determines whether a state of charge of an exchangeable battery module in a power source module is lower than a threshold value, for example 10%. If the state of charge is lower than the threshold value, a turn-off step is performed. If the state of charge is not lower than the threshold value, the device control unit determines whether the exchangeable battery module is in an abnormal state. If the exchangeable battery module is in the abnormal state, the turn-off step is then performed. In the turn-off step, the device control unit stops a torque output of an external device (for example, a motor) through a main battery management control unit. After performing the turn-off step, the device control unit determines whether the output current of the first exchangeable battery module is zero. If YES, the device control unit activates another exchangeable battery module through the main battery management control unit for providing required power to the external device.

The power source module of the disclosure can select the quantity of the exchangeable battery modules and socket modules to be utilized according to demand. A portion of the exchangeable battery modules can be plugged in or out according to a user's requirement during a usage period, so that the user can program the quantity of exchangeable battery modules to be used in advance, similar to a conventional manner of refueling, and change or charge required exchangeable battery modules before a trip.

### BRIEF DESCRIPTION OF THE SEVERAL VIEWS OF THE DRAWINGS

The accompanying drawings, which are incorporated in and constitute a part of this specification, illustrate embodiments of the disclosure and, together with the description, serve to explain the principles of the invention.

FIG. 1 shows a schematic view of a power source module in accordance with an exemplary embodiment;

FIG. 2 shows a schematic view of a power source module in accordance with another exemplary embodiment;

FIG. 3 shows a schematic view of a power source module in accordance with yet another exemplary embodiment;

FIG. 4 shows a schematic view of a power source module in accordance with yet another exemplary embodiment;

FIG. 5 shows a schematic view of a power source module in accordance with yet another exemplary embodiment;

FIG. 6 shows a schematic view illustrating an exemplary embodiment of a method of using a power source module; and

FIG. 7 shows a schematic view illustrating another exemplary embodiment of a method of using a power source module.

### DETAILED DESCRIPTION OF THE INVENTION

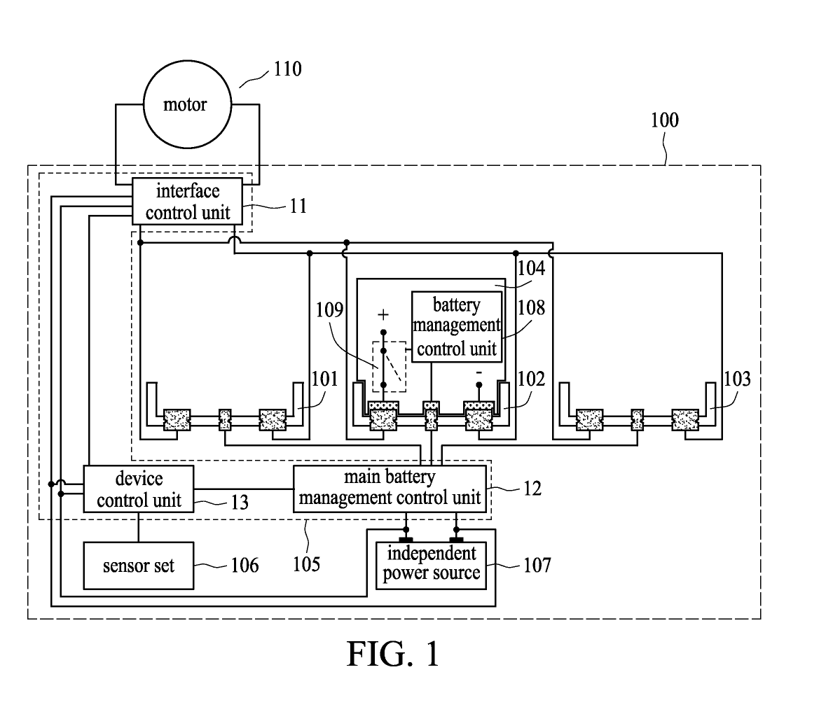

FIG. 1 shows a diagram of a power source module in accordance with an exemplary embodiment. The power source module 100 comprises socket modules 101-103, an exchangeable battery module 104, a system control unit 105, a sensor set 106, and an independent power source 107. The socket modules 101-103 are connected in parallel. The exchangeable battery module 104 can be inserted into any socket module of the socket modules 101-103. In accordance with one exemplary embodiment, the exchangeable battery module 104 is inserted into the socket module 102. However, the disclosure should not be limited to the embodiment. The system control unit 105 is configured to transmit an instruction signal to control a switch 109 of the exchangeable battery module 104 according to a state of charge of the exchangeable battery module 104, a sensing result, and operating information of an external device. The external device may be, for example, a motor or a charger. In accordance with one exemplary embodiment, the external device is a motor 110. However, the disclosure should not be limited to the embodiment. The exchangeable battery module 104 comprises a battery management control unit 108 utilized for measuring the state of charge of the exchangeable battery module 104, or controlling the switch 109 of the exchangeable battery module 104 according to the instruction signal. In accordance with one exemplary embodiment, the system control unit 105 controls the switch 109 of the exchangeable battery module 104 through the battery management control unit 108, so as to discharge the exchangeable battery module 104. However, the disclosure should not be limited to the embodiment.

The system control unit 105 comprises an interface control unit 11, a main battery management control unit 12, and a device control unit 13. The interface control unit 11 is configured to control the motor 110 and provide the operating information of the motor 110. The main battery management control unit 12 is configured to transmit the instruction signal, or obtain the state of charge of the exchangeable battery module 104 from the battery management control unit 108. The device control unit 13 controls the main battery management control unit 12 for transmitting the instruction signal according to the state of charge of the exchangeable battery module 104, the sensing result, and the operating information of the motor 110, so as to control the switch 109 of the exchangeable battery module 104. The sensor set 106 is configured to generate the sensing result, wherein the sensing result can be conditions of the exchangeable battery module 104, current of the exchangeable battery module 104, speed of the vehicle, accelerator pedal position, a braking signal, or a combination thereof. The independent power source 107 is configured to provide required power to the system control unit 105 or the sensor set 106 as shown in FIG. 1. In accordance with one exemplary embodiment, the exchangeable battery module 104 also provides the required power to the main battery management control unit 12. However, the disclosure should not be limited to the embodiment.

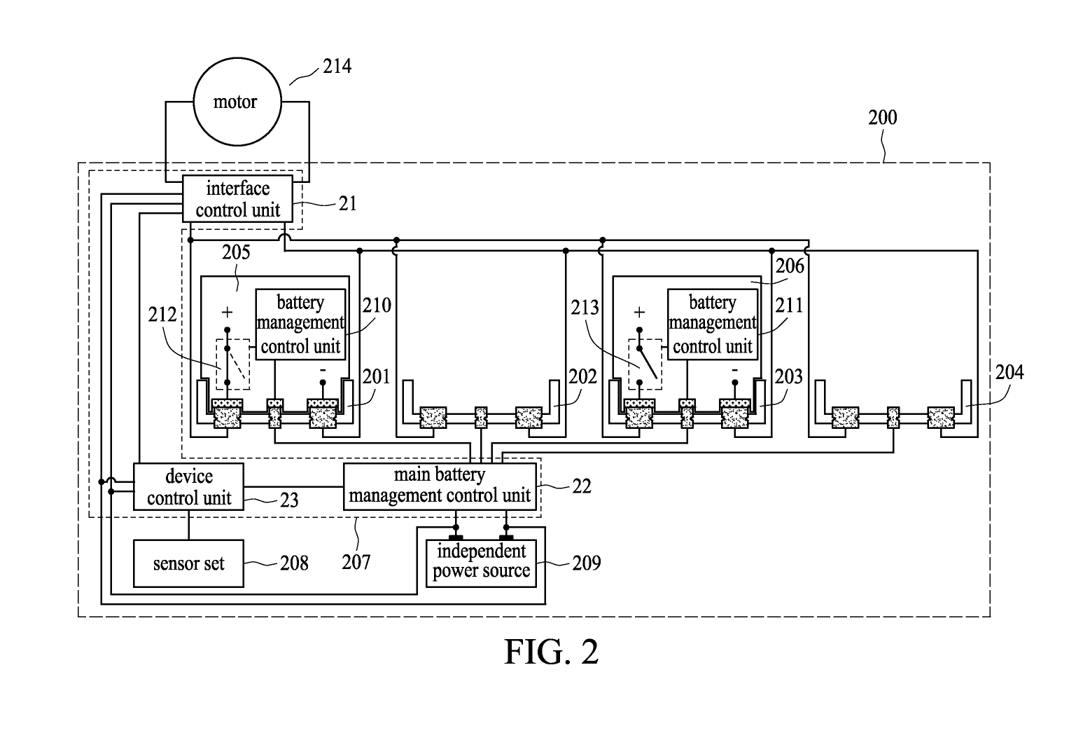

FIG. 2 shows a diagram of a power source module in accordance with another exemplary embodiment. The power source module 200 comprises socket modules 201-204, exchangeable battery modules 205-206, a system control unit 207, a sensor set 208, and an independent power source 209. The socket modules 201-204 are connected in parallel. The exchangeable battery module 205 or 206 can be inserted into any of the socket modules 201-204. In accordance with one exemplary embodiment, the exchangeable battery modules 205 and 206 are inserted into the socket modules 201 and 203, respectively. However, the disclosure should not be limited to the embodiment. The system control unit 207 transmits instruction signals to battery management control units 210 and 211, respectively, according to a state of charge of the exchangeable battery modules 205 and 206, a sensing result, and operating information of an external device, so as to control a switch 212 of the exchangeable battery module 205 and a switch 213 of the exchangeable battery module 206. Therefore, only one exchangeable battery module is charged or discharged during a charging and discharging period. The external device may be, for example, a motor or a charger. In accordance with one exemplary embodiment, the external device is a motor 214. However, the disclosure should not be limited to the embodiment.

The system control unit 207 comprises an interface control unit 21, a main battery management control unit 22, and a device control unit 23. The interface control unit 21 is configured to control the motor 214 and provide the operating information of the motor 214. The main battery management control unit 22 is configured to obtain the state of charge of the exchangeable battery modules 205 and 206, or transmit the instruction signal to the battery management control units 210 and 211. The device control unit 23 is configured to control the main battery management control unit 22 for transmitting the instruction signal according to the state of charge of the exchangeable battery modules 205 and 206, the sensing result and the operating information of the motor 214, so as to control a switch 212 of the exchangeable battery module 205 and a switch 213 of the exchangeable battery module 206. The battery management control units 210 and 211 are configured to measure status and the state of charge of the exchangeable battery modules 205 and 206, or to control a switch 212 or switch 213 according to the instruction signal. The sensor set 208 is configured to generate the sensing result, wherein the sensing result can be conditions of the exchangeable battery modules 205 and 206, current of the exchangeable battery modules 205 and 206, speed of the vehicle, accelerator pedal position, a braking signal, or the combination thereof.

The required power to the system control unit 207 or the sensor set 208 is either provided by the exchangeable battery module 205, in accordance with one exemplary embodiment by the independent power source 209.

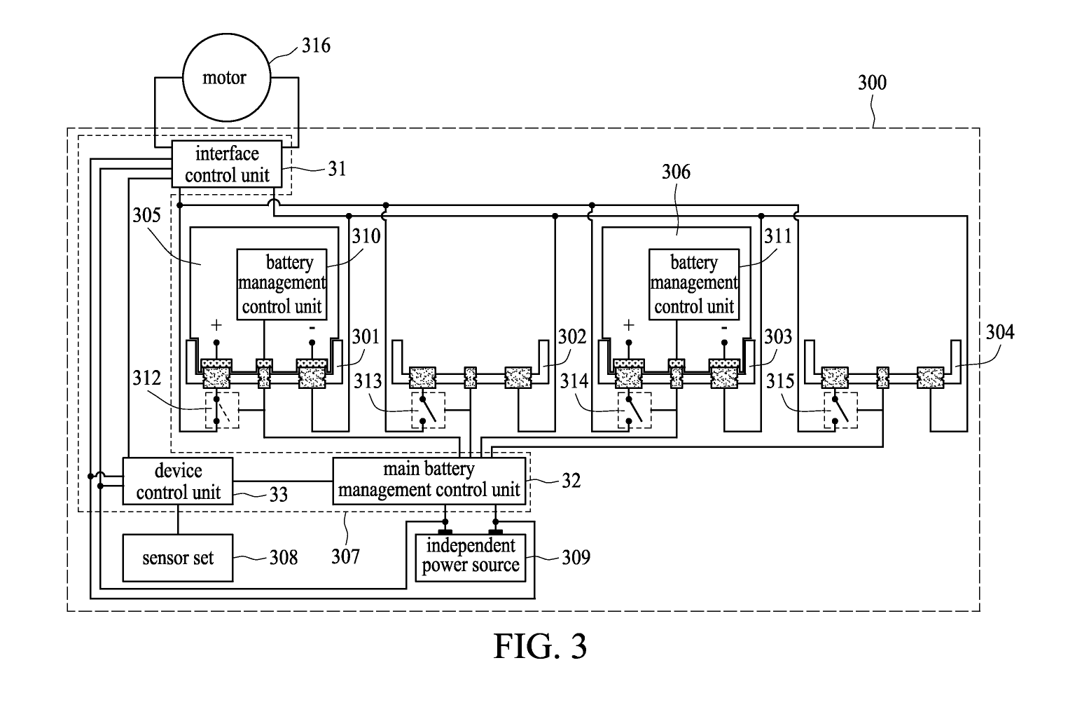

FIG. 3 shows a diagram of a power source module in accordance with yet another exemplary embodiment. The power source module 300 comprises socket modules 301-304, exchangeable battery modules 305-306, a system control unit 307, a sensor set 308, and an independent power source 309. The socket modules 301-304 are connected in parallel. The exchangeable battery module 305 or 306 can be inserted into any of the socket modules 301-304. In accordance with one exemplary embodiment, the exchangeable battery modules 305 and 306 are inserted into the socket modules 301 and 303, respectively. However, the disclosure should not be limited to the embodiment. The system control unit 307 controls switches 312-315 of the socket modules 301-304 according to a state of charge of the exchangeable battery modules 305 and 306, a sensing result, and operating information of an external device, so as to charge or discharge only one exchangeable battery module during a charging and discharging period. The external device may be, for example, a motor or a charger. In accordance with one exemplary embodiment, the external device is a motor 316. However, the disclosure should not be limited to the embodiment. The battery management control units 310 and 311 are configured to measure status and the state of charge of the exchangeable battery modules 305 and 306.

The system control unit 307 comprises an interface control unit 31, a main battery management control unit 32, and a device control unit 33. The interface control unit 31 is configured to control the motor 316 and provide the operating information of the motor 316. The main battery management control unit 32 is configured to control switches 312-315, or to obtain the state of charge of the exchangeable battery modules 305 and 306 from the battery management control units 310 and 311. The device control unit 33 is configured to control the main battery management control unit 32 for controlling the switches 312-315 according to the state of charge of the exchangeable battery modules 305 and 306, the sensing result and the operating information of the motor 316. The sensor set 308 is configured to generate the sensing result, wherein the sensing result can be conditions of the exchangeable battery modules 305 and 306, current of the exchangeable battery modules 305 and 306, speed of the vehicle, accelerator pedal position, a braking signal, or the combination thereof.

The required power to the system control unit 307 or the sensor set 308 is either provided by the exchangeable battery module 305, in accordance with one exemplary embodiment by the independent power source 309.

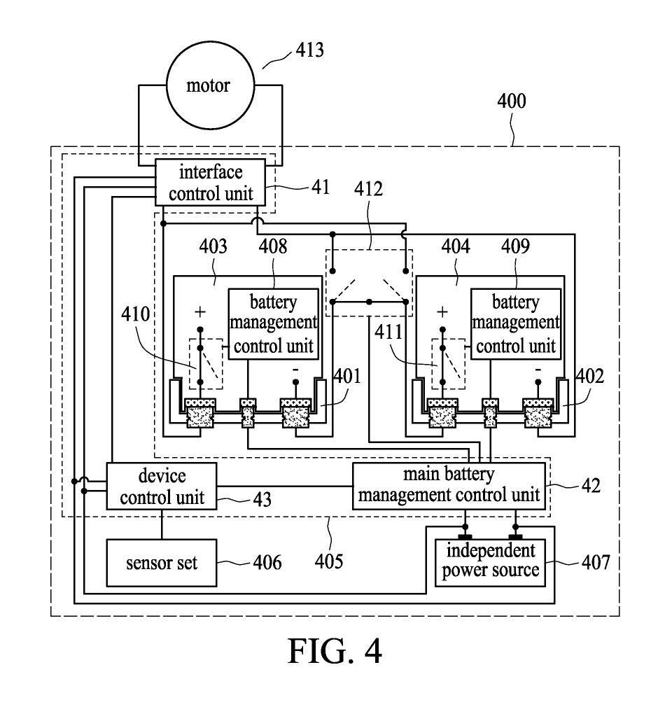

FIG. 4 shows a diagram of a power source module in accordance with yet another exemplary embodiment. The power source module 400 comprises socket modules 401-402, exchangeable battery modules 403-404, a system control unit 405, a sensor set 406, and an independent power source 407. In accordance with one exemplary embodiment, the exchangeable battery modules 403 and 404 are inserted into the socket modules 401 and 402, respectively. However, the disclosure should not be limited to the embodiment. The system control unit 405 is configured to transmit instruction signals to battery management control units 408 and 409 for controlling a switch 410 of the exchangeable battery modules 403 and a switch 411 of the exchangeable battery modules 404, respectively, according to a state of charge of the exchangeable battery modules 403 and 404, a sensing result, and operating information of a motor 413. In addition, the system control unit 405 also controls a switch 412 for switching the connection states of the socket modules 401 and 402. In accordance with one exemplary embodiment, the socket modules 401 and 402 are connected in series. However, the disclosure should not be limited to the embodiment. The battery management control units 408 and 409 are configured to measure status and the state of charge of the exchangeable battery modules 403 and 404, or to control the switch 410 or 411 according to the instruction signal.

The system control unit 405 comprises an interface control unit 41, a main battery management control unit 42, and a device control unit 43. The interface control unit 41 is configured to control the motor 413 and provide the operating information of the motor 413. The main battery management control unit 42 is configured to transmit instruction signals to battery management control units 408 and 409 for controlling the switches 410 and 411, configured to control the switch 412 for switching the connection states of the socket modules 401 and 402, or configured to obtain the state of charge of the exchangeable battery modules 403 and 404 through the battery management control units 408 and 409. The device control unit 43 is configured to control the main battery management control unit 42 for transmitting the instruction signal according to the state of charge of the exchangeable battery modules 403 and 404, the sensing result and the operating information of the motor 413, so as to control the switch 410 of the exchangeable battery module 403 and the switch 411 of the exchangeable battery module 404 or control the switch 412 for switching connection states of the socket modules 401 and 402. The sensor set 406 is configured to generate the sensing result, wherein the sensing result can be conditions of the exchangeable battery modules 403 and 404, current of the exchangeable battery modules 403 and 404, speed of the vehicle, accelerator pedal position, a braking signal, or the combination thereof. The independent power source 407 is configured to provide required power to the system control unit 405 or the sensor set 406. In accordance with one exemplary embodiment, the exchangeable battery modules 403 and 404 also provide required power to the main battery management control unit 42 during the discharging period. However, the disclosure should not be limited to the embodiment.

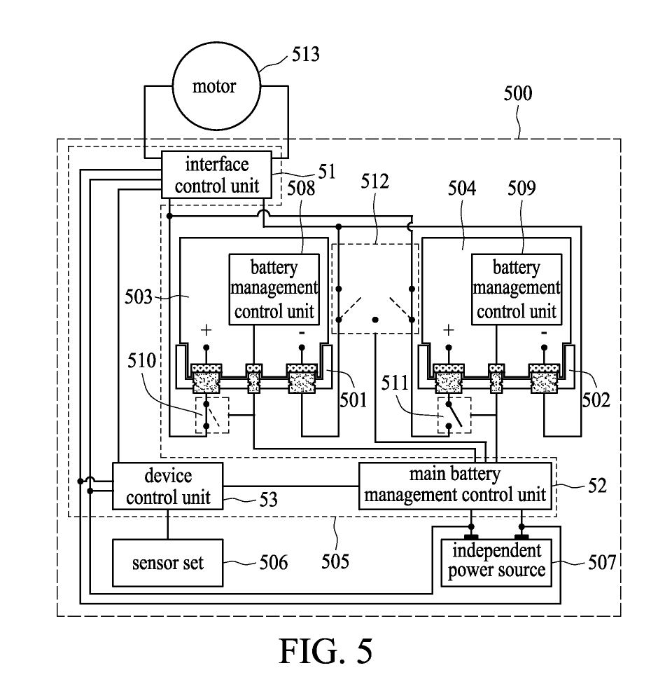

FIG. 5 shows a diagram of a power source module in accordance with yet another exemplary embodiment. The power source module 500 comprises socket modules 501-502, exchangeable battery modules 503-504, a system control unit 505, a sensor set 506, and an independent power source 507. In accordance with one exemplary embodiment, the exchangeable battery modules 503 and 504 are inserted into the socket modules 501 and 502, respectively. However, the disclosure should not be limited to the embodiment. The system control unit 505 is configured to control switches 510-511 of the socket modules 501-502 according to a state of charge of the exchangeable battery modules 503 and 504, a sensing result, and operating information of a motor 513. In addition, the system control unit 505 also controls a switch 512 for switching the connection states of the socket modules 501 and 502. In accordance with one exemplary embodiment, the socket modules 501 and 502 are connected in parallel. However, the disclosure should not be limited to the embodiment. The battery management control units 508 and 509 are configured to measure status and the state of charge of the exchangeable battery modules 503 and 504.

The system control unit 505 comprises an interface control unit 51, a main battery management control unit 52, and a device control unit 53. The interface control unit 51 is configured to control the motor 513 and to provide the operating information of the motor 513. The main battery management control unit 52 is configured to control the switches 510 and 511, to control the switch 512 for switching the connection states of the socket modules 501 and 502, or to obtain the state of charge of the exchangeable battery modules 503 and 504 through the battery management control units 508 and 509. The term “control a switch” means that a switch is driven to an ON state from an OFF state or to an OFF state from an ON state. The device control unit 53 is configured to control the switches 510 and 511 or to control the switch 512 for switching the state of charge of the socket modules 501 and 502 through the main battery management control unit 52 according to the state of charge of the exchangeable battery modules 503 and 504, the sensing result and the operating information of the motor 513. The sensor set 506 is configured to generate the sensing result, wherein the sensing result can be conditions of the exchangeable battery modules 503 and 504, current of the exchangeable battery modules 503 and 504, speed of the vehicle, accelerator pedal position, a braking signal, or the combination thereof.

The required power to the system control unit 505 or the sensor set 506 is either provided by the exchangeable battery module 503, in accordance with one exemplary embodiment by the independent power source 507.

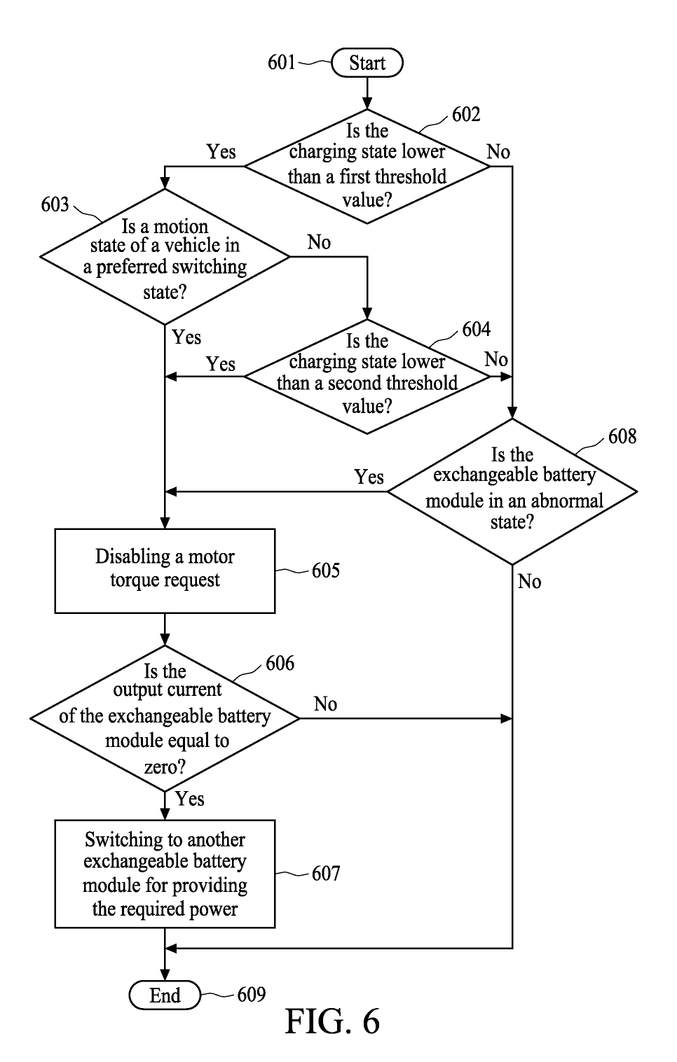

FIG. 6 shows a flowchart illustrating an exemplary embodiment of a method of using a power source module. In order to enable persons skilled in the art to understand the contents and to practice the present invention, the flow of the method of using the power source module is illustrated in conjunction with FIGS. 2 and 6. Assume, for example, that a user uses an exchangeable battery module (i.e., the exchangeable battery module 205) with the least electric quantity in the power source modules 200 to provide the required power to the motor 214. In step 601, the flow starts. In step 602, the device control unit 23 determines whether the state of charge of the exchangeable battery module 205 is lower than a first threshold value, for example, but not limited to, 10%. If YES, the device control unit 23 determines if a motion state of a vehicle is in a preferred switching state in step 603. The preferred switching states comprise a static state, a coasting state, a braking state, or a downslope state. The above states can be determined according to a sensing result provided by a sensor set 208. The sensing result comprises the state of charge of the exchangeable battery module 205, current of the exchangeable battery module 205, speed of the vehicle, accelerator pedal position, a braking signal, or the combination thereof. However, the disclosure should not be limited to the embodiment. If YES, i.e., if the motion state of the vehicle is in a preferred switching state, then the device control unit 23 turns off the switch 212 through the main battery management control unit 22 for stopping a torque output of the motor 214 in step 605. If NO, i.e., if the motion state of the vehicle is not in a preferred switching state, then in step 604 the device control unit 23 determines whether the state of charge of the exchangeable battery module 205 is lower than a second threshold value, for example, but not limited to, 5%. If YES, i.e., if the state of charge of the exchangeable battery module is lower than a second threshold value, then the device control unit 23 turns off the switch 212 through the main battery management control unit 22 for stopping the torque output of the motor 214 in step 605. If NO, i.e., if the state of charge of the exchangeable battery module is not lower than a second threshold value, then the device control unit 23 determines whether the exchangeable battery module 205 is in an abnormal state in step 608. The abnormal state can be, for example, an overheating state, an over current state, or a state where the voltage of the exchangeable battery module is out of an allowable range. If YES, i.e., if the exchangeable battery module is in an abnormal state, then the device control unit 23 is disabled the motor torque request at interface control unit 21 in order to stop the torque output of the motor 214 in step 605. In step 606, the device control unit 23 determines whether the output current of the exchangeable battery module 205 is equal to zero. If NO, the flow ends in step 609; if YES, the device control unit 23 turns on the switch 213 of the exchangeable battery module 206 through the main battery management control unit 22 for providing the required power to the motor 214 in step 607. Finally, the flow ends in step 609. The flow of the method of using the power source module is executed repeatedly during the discharging period of the power source module, so that an exchangeable battery module for use can be switched on at the required moment.

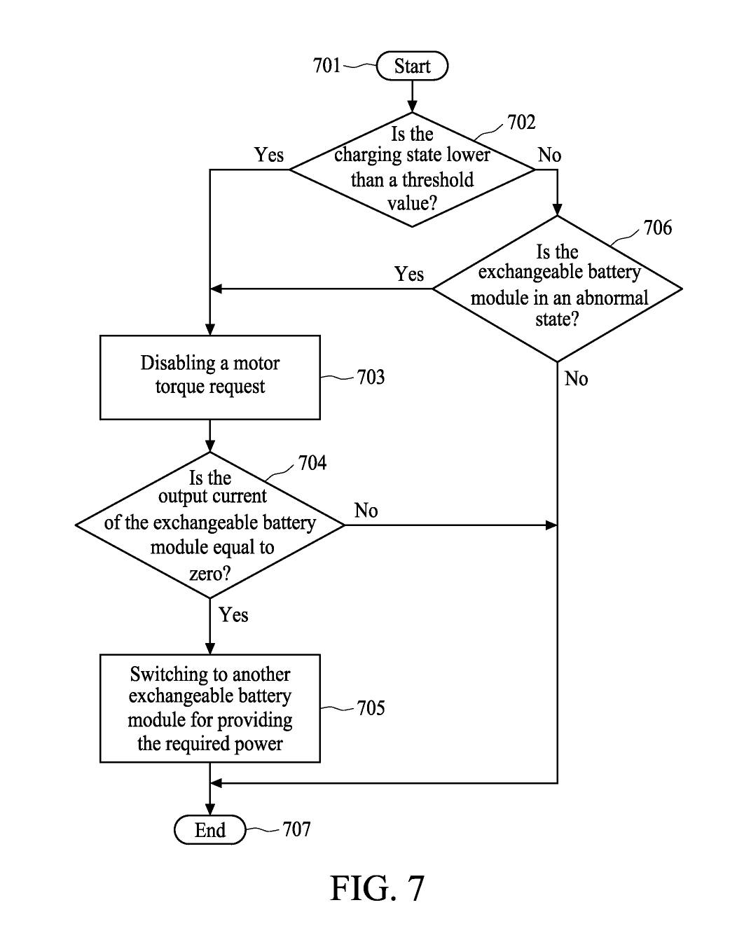

FIG. 7 shows a flowchart illustrating another exemplary embodiment of a method of using a power source module. In order to enable persons skilled in the art to understand the contents and to practice the present invention, the flow of the method of using the power source module is illustrated in conjunction with FIGS. 2 and 7. Assume that a user uses an exchangeable battery module (i.e., the exchangeable battery module 205) with the least electric quantity among the power source modules 200 to provide the required power to the motor 214. In step 701, the flow starts. In step 702, the device control unit 23 determines whether the state of charge of the exchangeable battery module 205 is lower than a first threshold value, for example, but not limited to, 10%. If YES, the device control unit 23 is disabled the motor torque request at interface control unit 21 in order to stop a torque output of the motor 214 in step 703. If NO, the device control unit 23 determines whether the exchangeable battery module 205 is in an abnormal state in step 706. The abnormal state can be, for example, an overheating state, an over current state, or a state where the voltage of the exchangeable battery module is out of an allowable range. If YES, i.e., if the exchangeable battery module is in an abnormal state, then the device control unit 23 is disabled the motor torque request at interface control unit 21 in order to stop the torque output of the motor 214 in step 703. In step 704, the device control unit 23 determines whether the output current of the exchangeable battery module 205 is equal to zero. If NO, the flow ends in step 707; if YES, the device control unit 23 turns on the switch 213 of the exchangeable battery module 206 through the main battery management control unit 22 for providing the required power to the motor 214 in step 705. Finally, the flow ends in step 707. The flow of the method of using the power source module is executed repeatedly during the discharging period of the power source module, so that an exchangeable battery module for use can be switched at the required moment.

The above-described exemplary embodiments are intended to be illustrative of the invention principle only. Those skilled in the art may devise numerous alternative embodiments without departing from the scope of the following claims.

We claim:

1. A power source module, comprising:
a plurality of socket modules, wherein the plurality of the socket modules are connected in parallel;
at least one exchangeable battery module arbitrarily inserted into at least one socket module of the plurality of the socket modules; and
at least one system control unit configured to transmit at least one instruction signal for controlling a switch of the at least one exchangeable battery module according to a state of charge of the at least one exchangeable battery module, a sensing result, and operating information of an external device, so as to charge or discharge only one exchangeable battery module during a charging and discharging period.

2. The power source module of claim 1, wherein the at least one exchangeable battery module has a battery management control unit configured to measure status and the state of charge of the at least one exchangeable battery module, or to control the switch of the at least one exchangeable battery module according to the instruction signal.

3. The power source module of claim 1, further comprising a sensor set for generating the sensing result.

4. The power source module of claim 1, wherein the sensing result is conditions of the at least one exchangeable battery module, current of the at least one exchangeable battery module, speed of the vehicle, accelerator pedal position, a braking signal, or the combination thereof.

5. The power source module of claim 3, further comprising an independent power source for providing required power to the at least one system control unit or the sensor set.

6. The power source module of claim 2, wherein the system control unit comprises:
an interface control unit configured to control the external device and provide the operating information of the external device;
a main battery management control unit configured to transmit the at least one instruction signal, or obtain the state of charge of the at least one exchangeable battery module through the battery management control unit; and
a device control unit configured to control the main battery management control unit for transmitting the at least one instruction signal according to the state of charge of the at least one exchangeable battery module, the sensing result, and the operating information of the external device, so as to control the switch of the at least one exchangeable battery module.

7. A power source module, comprising:
a plurality of socket modules, wherein the plurality of the socket modules are connected in parallel;
at least one exchangeable battery module arbitrarily inserted into at least one socket module of the plurality of the socket modules; and
at least one system control unit configured to control a switch of the at least one socket module according to a state of charge of the at least one exchangeable battery module, a sensing result, and operating information of an external device, so as to charge or discharge only one exchangeable battery module during a charging and discharging period.

8. The power source module of claim 7, wherein the at least one exchangeable battery module has a battery management control unit configured to measure status and the state of charge of the at least one exchangeable battery module.

9. The power source module of claim 7, further comprising a sensor set for generating the sensing result.

10. The power source module of claim 7, wherein the sensing result is conditions of the at least one exchangeable battery module, current of the at least one exchangeable battery module, speed of the vehicle, accelerator pedal position, a braking signal, or the combination thereof.

11. The power source module of claim 9, further comprising an independent power source for providing required power to the at least one system control unit or the sensor set.

12. The power source module of claim 8, wherein the system control unit comprises:
an interface control unit configured to control the external device and provide the operating information of the external device;
a main battery management control unit configured to control the switch of the at least one socket module, or to obtain the state of charge of the at least one exchangeable battery module through the battery management control unit; and
a device control unit configured to control the main battery management control unit according to the state of charge of the at least one exchangeable battery module, the sensing result, and the operating information of the external device, so as to control the switch of the at least one socket module.

13. A power source module, comprising:
a plurality of socket modules;
at least one exchangeable battery module arbitrarily inserted into at least one socket module of the plurality of the socket modules; and
at least one system control unit configured to either switch the plurality of socket modules and battery modules connected in parallel or in series according to the load requirement of the electric vehicle, or the plurality of socket modules are connected in parallel to transmit at least one instruction signal for controlling a switch of the at least one exchangeable battery module according to a state of charge of the at least one exchangeable battery module, a sensing result, and operating information of an external device, so as to charge or discharge only one exchangeable battery module during a charging and discharging period.

14. The power source module of claim 13, wherein the at least one exchangeable battery module has a battery management control unit configured to measure status and the state of charge of the at least one exchangeable battery module, or control the switch of the at least one exchangeable battery module according to the instruction signal.

15. The power source module of claim 13, further comprising a sensor set for generating the sensing result.

16. The power source module of claim 13, wherein the sensing result is conditions of the at least one exchangeable battery module, current of the at least one exchangeable battery module, speed of the vehicle, accelerator pedal position, a braking signal, or the combination thereof.

17. The power source module of claim 15, further comprising an independent power source for providing required power to the at least one system control unit or the sensor set.

18. The power source module of claim 14, wherein the system control unit comprises:
an interface control unit configured to control the external device and provide the operating information of the external device;
a main battery management control unit configured to transmit the at least one instruction signal, switch the plurality of socket modules connected in parallel or in series, or obtain the state of charge of the at least one exchangeable battery module through the battery management control unit; and
a device control unit configured to control the main battery management control unit for transmitting the at least one instruction signal or switching the plurality of socket modules connected in parallel or in series according to the state of charge of the at least one exchangeable battery module, the sensing result, and the operating information of the external device, so as to control the switch of the at least one exchangeable battery module.

19. A power source module, comprising:
a plurality of socket modules;
at least one exchangeable battery module arbitrarily inserted into at least one socket module of the plurality of the socket modules; and
at least one system control unit configured to either switch the plurality of socket modules and battery modules connected in parallel or in series according to the load requirement of the electric vehicle, or the plurality of socket modules are connected in parallel or to control a switch of the at least one socket module according to a state of charge of the at least one exchangeable battery module, a sensing result, and operating information of an external device, so as to charge or discharge only one exchangeable battery module during a charging and discharging period.

20. The power source module of claim 19, wherein the at least one exchangeable battery module has a battery management control unit configured to measure status and the state of charge of the at least one exchangeable battery module.

21. The power source module of claim 19, further comprising a sensor set for generating the sensing result.

22. The power source module of claim 19, wherein the sensing result is conditions of the at least one exchangeable battery module, current of the at least one exchangeable battery module, speed of the vehicle, accelerator pedal position, a braking signal, or the combination thereof.

23. The power source module of claim 21, further comprising an independent power source for providing required power to the at least one system control unit or the sensor set.

24. The power source module of claim 20, wherein the system control unit comprises:
an interface control unit configured to control the external device and provide the operating information of the external device;
a main battery management control unit configured to control the switch of the at least one socket module, switch the plurality of socket modules connected in parallel or in series, or obtain the state of charge of the at least one exchangeable battery module through the battery management control unit; and
a device control unit configured to control the switch of the at least one socket module or switch the plurality of socket modules connected in parallel or in series according to the state of charge of the at least one exchangeable battery module, the sensing result, and the operating information of the external device.

25. A method for using a power source module, comprising:
determining whether a state of charge of a first exchangeable battery module is lower than a first threshold value and a second threshold value and generating a first decision and a second decision, respectively;
determining if a motion state of a vehicle is in a preferred switching state and generating a third decision according to the first decision;
determining whether the first exchangeable battery module is in an abnormal state and generating a fourth decision;
stopping a torque output of an external device according to the second decision, or the third decision, or the fourth decision;
determining whether output current of the first exchangeable battery module is equal to zero and generating a fifth decision; and
activating a second exchangeable battery module according to the fifth decision for providing required power to the external device.

26. The method of claim 25, wherein the external device is a motor.

27. The method of claim 25, wherein the preferred switching states comprise a static state, a coasting state, a braking state, or a downslope state.

28. The method of claim 25, wherein the abnormal states comprise an overheating state, an over current state, or a state where a voltage is out of an allowable range.

29. A method for using a power source module, comprising:
determining whether a state of charge of a first exchangeable battery module is lower than a threshold value and generating a first decision;
determining whether the first exchangeable battery module is in an abnormal state and generating a second decision;
stopping a torque output of an external device according to the first decision or the second decision;
determining whether output current of the first exchangeable battery module is equal to zero and generating a third decision; and
activating a second exchangeable battery module according to the third decision for providing required power to the external device.

30. The method of claim 29, wherein the external device is a motor.

31. The method of claim 29, wherein the abnormal states comprise an overheating state, an over current state, or a state where a voltage is out of an allowable range.
